(19) United States
(12) Patent Application Publication
(10) Pub. No.: US 2022/0080366 A1
(43) Pub. Date: Mar. 17, 2022

(54) COMPRESSED METALLIC FOAM-SUPPORTED ZEOLITE MEMBRANES FOR ALCOHOL DEHYDRATION

(71) Applicant: Engi-Mat Co., Lexington, KY (US)

(72) Inventors: Haibing Wang, Lexington, KY (US); Xiansen Li, Lexington, KY (US); Claudia Goggin, Lexington, KY (US)

(21) Appl. No.: 17/474,542

(22) Filed: Sep. 14, 2021

Related U.S. Application Data
(60) Provisional application No. 63/079,533, filed on Sep. 17, 2020.
(60) Provisional application No. 63/108,558, filed on Nov. 2, 2020.

(51) Int. Cl. B01D 71/02; C02F 1/44; B01D 69/10

(52) U.S. Cl. CPC B01D 71/028; C02F 1/44; C02F 2101/34; B01D 2325/02; B01D 69/10

(57) ABSTRACT

Composite structures composed of inorganic membranes or polymer membranes supported on and integrated with compressed metal foam supports are provided. Also provided are methods of making the composite structures from compressed reticulated metal foams and methods of using the composite structures as separation membranes in the dehydration of organic solutions.

### CROSS-REFERENCE TO RELATED APPLICATIONS

The present application claims priority to U.S. provisional patent application No. 63/079,533 that was filed Sep. 17, 2020, and U.S. provisional patent application No. 63/108,558 that was filed Nov. 2, 2020, the entire contents of both of which are incorporated herein by reference.

### REFERENCE TO GOVERNMENT RIGHTS

This invention was made with government support under DESC0017141 awarded by the Department of Energy. The government has certain rights in the invention.

### BACKGROUND

Many bioethanol plants in the U.S. run an energy-intensive pressure swing adsorption (PSA) process for the dehydration of organic solvents. However, PSA requires periodic adsorbent bed retrofitting, which is time-consuming and expensive. Emerging energy-efficient separation technologies such as membranes also can be used for ethanol dehydration. NaA zeolite membranes, in particular, are highly effective for the dehydration of various organic solvents due to their hydrophilic properties and molecular sieving effect. During operation, zeolite membrane systems do not require recycling. As a result, bioethanol manufacturers are able to reduce energy costs and increase production capacity by replacing PSA processes with zeolite membrane dehydration systems or by integrating zeolite membrane modules into their existing processes. Unfortunately, the production costs of NaA zeolite membranes are high, with most of the costs coming from the porous ceramic or metallic supports.

### SUMMARY

Supported membranes, methods of making the supported membranes, and methods of using the supported membranes in the separation of water and organic solvents, such as alcohols, are provided.

One example of a supported membrane includes: (a) a porous metal substrate having a first surface and a second surface disposed opposite the first surface, the porous metal substrate comprising a three-dimensional network of metal struts that define a plurality of open-cell pores; and (b) a membrane supported by and integrated with the porous metal substrate. The porous metal substrate can take on a variety of forms. For example, in some embodiments of the supported membranes, the porous metal substrate is planar, the first surface is a top surface of the planar porous metal substrate, the second surface is a bottom surface of the planar porous metal substrate, an edge surface spans the top surface and the bottom surface, and the metal struts are preferentially horizontally oriented parallel to planes defined by the top and bottom surfaces. In other, non-limiting embodiments of the supported membranes, the porous metal substrate forms a hollow cylinder, the first surface is an outer cylindrical surface, the second surface is an inner cylindrical surface, a first end surface is located at one end of the hollow cylinder, a second end surface is located at an opposing end of the hollow cylinder, and the metal struts are preferentially oriented along a circumferential direction of the hollow cylinder, an axial direction of the hollow cylinder, or both.

One example of a method of forming a supported membrane includes the steps of: providing a reticulated metal foam having an initial median pore size; compressing the reticulated metal foam to reduce the median pore size; seeding the reticulated metal foam with membrane seed particles; and forming a membrane from the membrane seed particles. Optionally, the compressed reticulated metal foam can be formed into a non-planar object, such as a hollow cylinder, to provide a non-planar supported membrane. In the method of forming a supported membrane, seeding the reticulated metal foam can take place prior to compressing the reticulated metal foam or after compressing the reticulated metal foam. In some examples of the methods, the compression reduces the median pore size by at least 50%. By way of illustration, an initial median pore size of at least 100 μm can be reduced to a median pore size that is smaller, but still at least 2 μm. In some embodiments of the methods, forming a membrane from the membrane seed particles comprises converting the membrane seed particles into a membrane via hydrothermal synthesis. The membrane can be, but need not be, an NaA zeolite.

One example of a method for separating water from a feed mixture comprising water and an organic solvent includes the steps of: exposing the feed mixture to a first surface of a supported membrane of a type described herein under hydrothermal conditions, creating a pressure difference between the first surface and the second surface, wherein the pressure at the first surface is greater than the pressure at the second surface, or vice versa, and water is selectively removed from the feed mixture via pervaporation through the hydrophilic zeolite membrane.

One example of a method of forming a supported polymer membrane includes the steps of: providing a reticulated metal foam having an initial median pore size; compressing the reticulated metal foam to reduce the median pore size; seeding the reticulated metal foam with ceramic filler particles to reduce the pore volume of the reticulated metal foam; and forming a polymer membrane over the ceramic filler particles and the reticulated metal foam. Optionally, the compressed reticulated metal foam can be formed into a non-planar object, such as a hollow cylinder, to provide a non-planar supported polymer membrane. In the method of forming a supported polymer membrane, seeding the reticulated metal foam can take place prior to compressing the reticulated metal foam or after compressing the reticulated metal foam. In some examples of the methods, the compression reduces the median pore size by at least 50%. By way of illustration, an initial median pore size of at least 100 μm can be reduced to a median pore size that is smaller, but still at least 2 μm.

### BRIEF DESCRIPTION OF THE DRAWINGS

Illustrative embodiments of the invention will hereafter be described with reference to the accompanying drawings, wherein like numerals denote like elements.

FIGS. 1A-1O show side views of uncompressed metal foams (FIGS. 1A-1D), side views of compressed metal foams (FIGS. 1E-1G), top views of uncompressed metal foams (FIGS. 1H-1K), and top views of compressed metal foams (FIGS. 1L-1O).

FIG. 2 is a schematic illustration of a planar rectangular foam rolled into a cylindrical foam.

FIG. 3 illustrates the difference between surface flatness and surface roughness.

FIGS. 4A-4C show metallic foams (dimensions: 5.6 cm×5.6 cm) used for NaA zeolite membrane synthesis: (FIG. 4A) Cu foam; (FIG. 4B) Ni foam; (FIG. 4C) stainless steel foam.

FIGS. 5A-5C show metallic foams pre-seeded with NaA zeolite crystals: (FIG. 5A) pre-seeded Cu foam; (FIG. 5B) pre-seeded Ni foam; and (FIG. 5C) pre-seeded stainless-steel foam.

FIGS. 6A-6C show metallic foams post-seeded with NaA zeolite crystals: (FIG. 6A) post-seeded Cu foam; (FIG. 6B) post-seeded Ni foam; and (FIG. 6C) post-seeded stainless-steel foam.

FIGS. 7A-7B show the scanning electron microscope (SEM) surface microstructure of a NaA zeolite membrane supported on a compressed Ni foam under different magnifications, (FIG. 7A) ×2000; (FIG. 7B) ×4000. The membrane was made using the pre-seeding method.

FIGS. 8A-8B show the SEM surface microstructure of a NaA zeolite membrane supported on a compressed Ni foam under different magnifications, (FIG. 8A) ×5000; (FIG. 8B) ×10000. The membrane was made using the post-seeding method.

FIG. 9 shows the effect of testing temperature on the water/ethanol separation performance of a NaA zeolite membrane prepared on a Ni foam using the pre-seeding method.

FIG. 10 shows the effect of testing temperature on the water/ethanol separation performance of a NaA zeolite membrane prepared on a Ni foam using the post-seeding method.

FIG. 11 shows pervaporation performance at different temperatures of a small-sized NaA zeolite membrane supported on a compressed Ni foam made using the pre-seeding method.

FIG. 12 shows the compressed foam of FIG. 1F with solid black lines indicating the orientation of struts.

FIG. 13 shows the distribution of strut orientation based on the solid black lines of FIG. 12.

### DETAILED DESCRIPTION

Composite structures comprising inorganic membranes, polymer membranes, or mixed matrix membranes (MMM) supported on and integrated with compressed metal foam supports are provided. Also provided are methods of making the composite structures and methods of using the composite structures in chemical separations.

The composite structures use readily available inexpensive metal foams as a starting material for the fabrication of supported membrane structures. By using low-cost metallic foams as porous supports, supported membrane structures can be synthesized in an economical way for a wide range of applications, including energy-efficient bioethanol dehydration.

The metal foams used to form the porous metal supports are compressible, highly porous, open-cell foams having large interconnected cellular pores that form irregular tortuous passages in the foam. Prior to compression, the metal foams typically have a large median pore size, rendering them unsuitable for many separation applications. For example, some embodiments of the metal foams have an initial median pore size of at least 50 μm. This includes metal foams having a median pore size of at least 100 μm, further includes metal foams having a median pore size of 200 μm, and still further includes metal foams having a median pore size of at least 300 μm. By way of illustration, metal foams having median pore sizes in the range from 50 μm to 1000 μm can be used. Pore sizes can be measured using software Image J.

The metal from which the foams are made includes single element metals and metal alloys. The metal can be selected based on the intended application of the composite structures. However, for applications in which the foam is acting only as a passive support structure, cost and availability may be important factors. Examples of metal foams that can be used include reticulated nickel (Ni), copper (Cu), and stainless-steel foams. Such foams are available commercially from Xiamen Tmax Battery Equipment Limited.

Initially, the metal foams have pore sizes that are too large to render them practical for use as supports in many applications, including membrane-based chemical separations such as alcohol dehydration. Therefore, the metal foam starting materials are compressed to form more compact foam supports. The foams are seeded with membrane seed particles and/or foam filler particles, either before or after compression, as discussed in greater detail below.

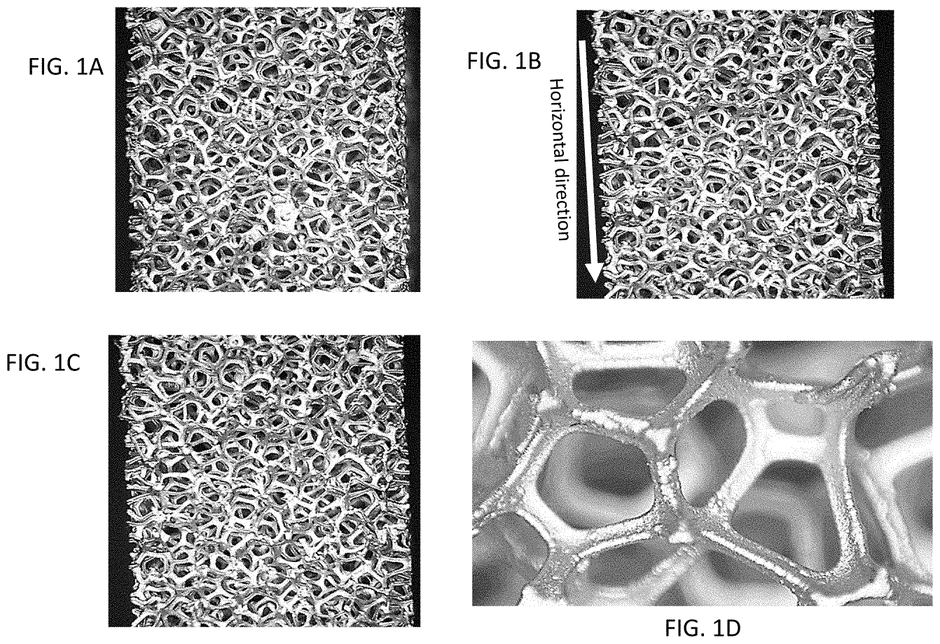

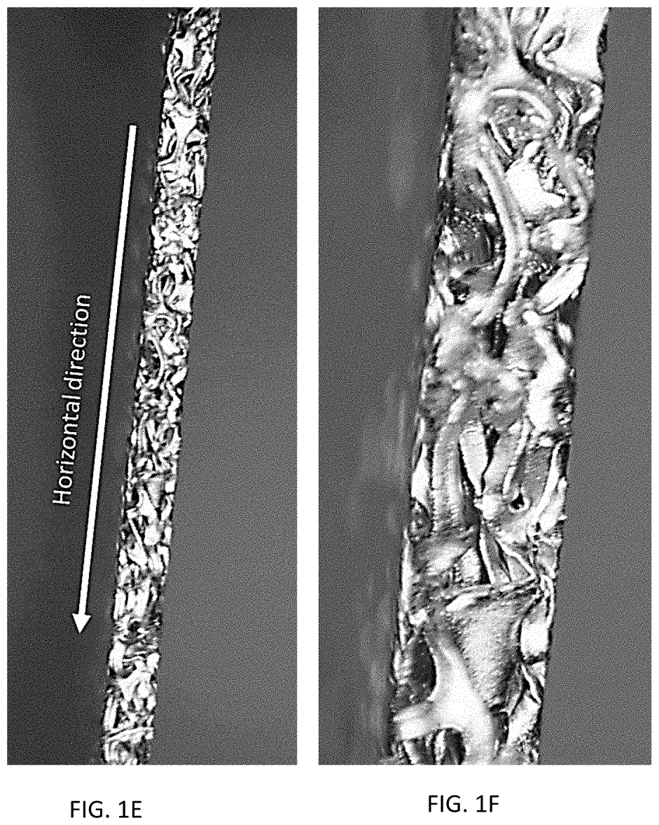

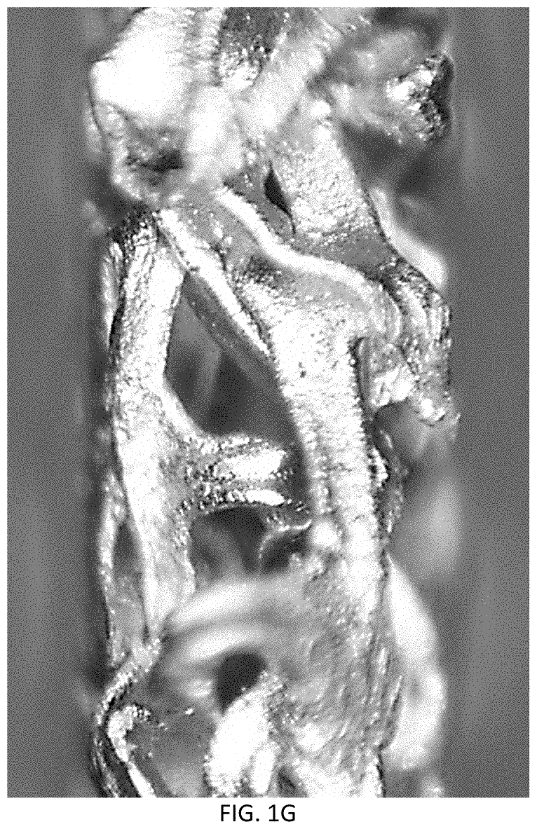

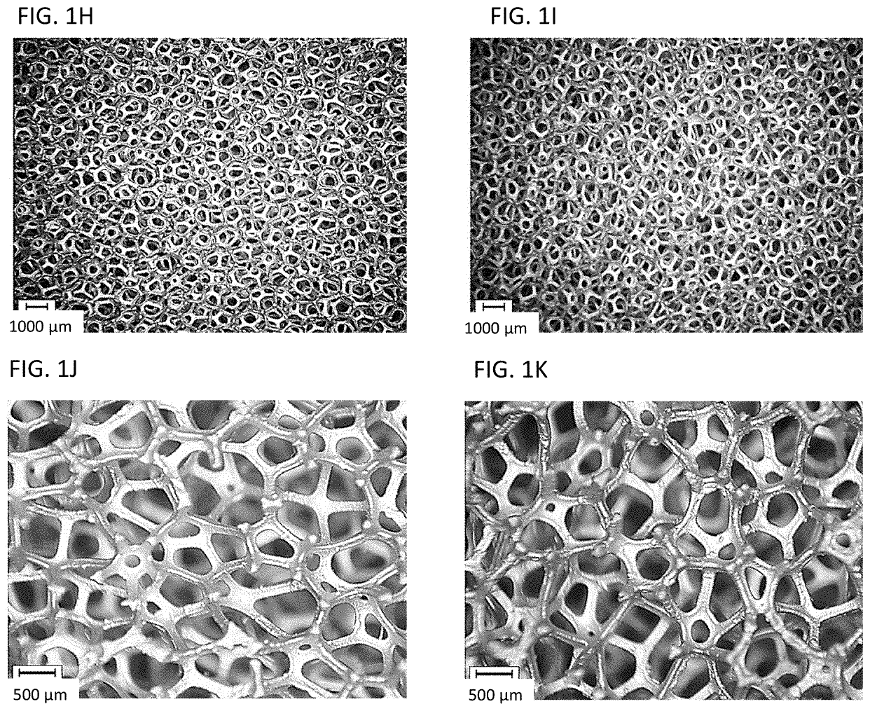

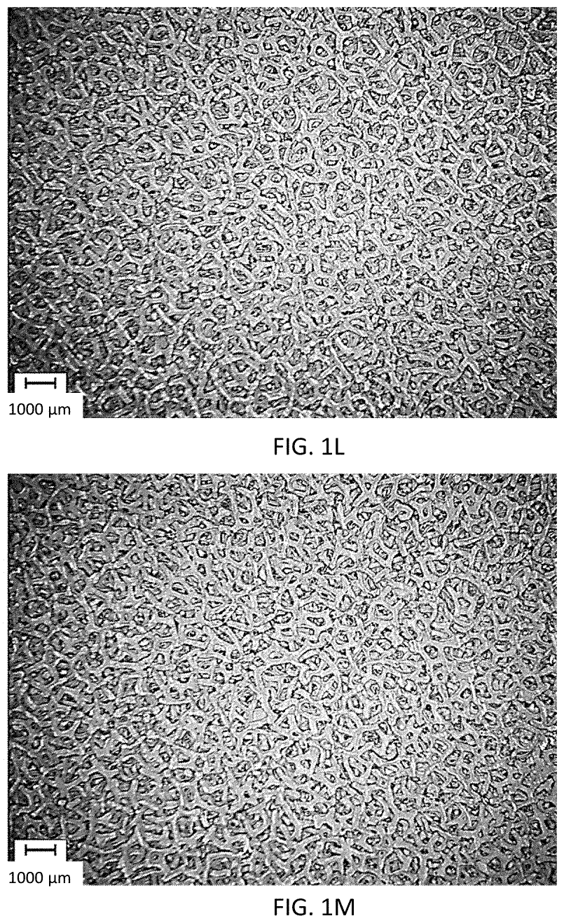

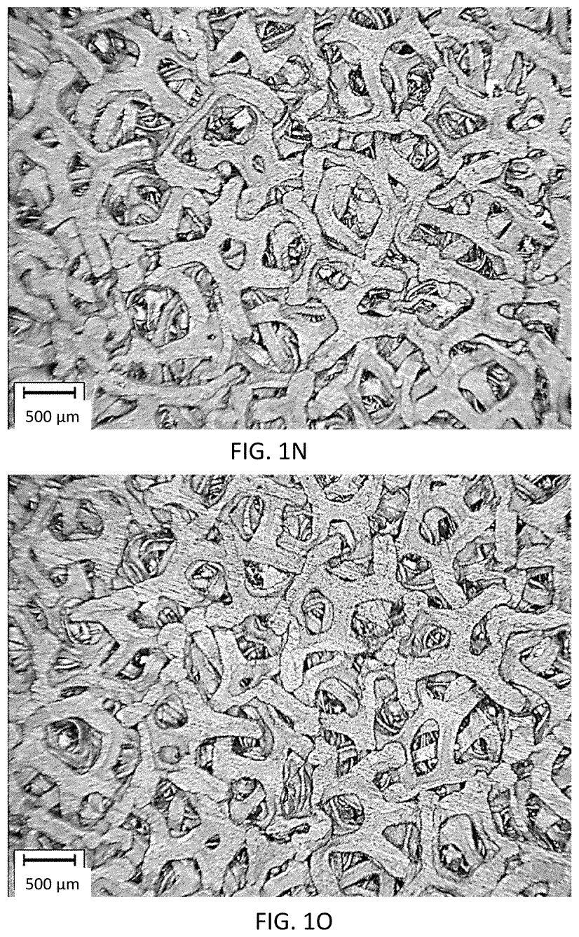

The initial metal foam starting material is compressed by applying pressure (pressing) to increase the density of the foam by reducing pore size, porosity, and volume. This can be accomplished, for example, by using uniaxial mechanical and/or hydraulic compression. Compressing the metal foams changes their morphology. These changes are evident in the scanning electron microscope images shown in FIGS. 1A-10. FIGS. 1A-1D show four images of uncompressed, reticulated, open-cell Ni foams, as viewed along the side edge; FIGS. 1E-1G show three images of compressed, reticulated, open-cell Ni foams, as viewed along the side edge; FIGS. 1H-1K show four images of uncompressed reticulated, open-cell Ni foams, as viewed along the top surface; and FIGS. 1L-1O show four images of compressed, reticulated, open-cell Ni foams, as viewed along the top surface.

One significant change is that the compression results in the reorientation of the metal struts within the foam's three-dimensional network structure, such that the struts become preferentially oriented along the horizontal direction. As used herein, the horizontal direction is the direction running perpendicular to the direction of the compressive force and parallel to the planes defined by the top and bottom surfaces of the compressed foams, as illustrated by the arrows in FIGS. 1A-1O. In a chemical separation, the horizontal direction would be perpendicular to the direction of fluid flow. This can be seen in a comparison of FIGS. 1A-1D with FIGS. 1E-1G. As can be seen in FIGS. 1A-1D, the metal struts in the 3D network structure are oriented isotropically, without a preferential orientation along any particular direction. In contrast, after compression, the metal struts in the 3D network have an anisotropic orientation distribution with a preferred orientation along the horizontal directions relative to the vertical direction, as shown in FIGS. 1E-1G.

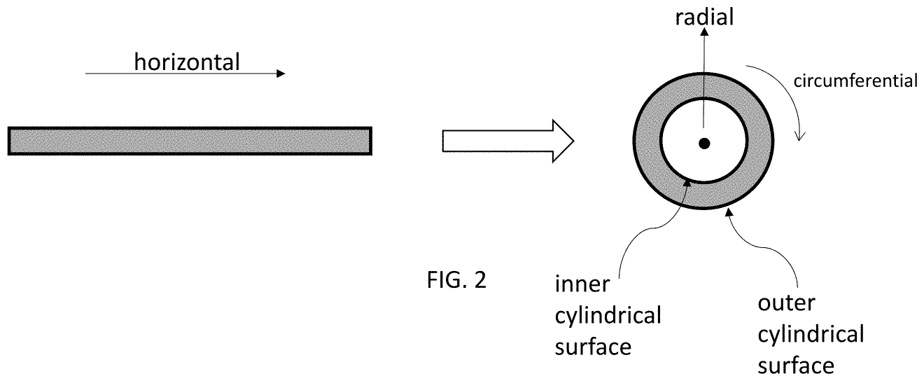

Although the foams in FIGS. 1E-1G have a square or rectangular perimeter, other perimeter shapes can be used, including circular. Moreover, although the foams and the supported membranes formed from the foams can have a substantially planar configuration, as illustrated in FIGS. 1E-1G, they can also have more complex non-planar configurations. For example, the foams and the supported membranes can be formed into a hollow cylinder by, for example, rolling a planar foam or supported membrane into a hollow tube and connecting the edges to seal the cylinder. The cylinder can be characterized by three directions: an axial direction, running parallel with the long axis of the cylinder; a radial direction, running perpendicular to the long axis of the cylinder; and a circumferential direction that follows the curve of the cylindrical wall. When the compressed foam is formed into a cylinder, the struts that were preferentially oriented along a horizontal direction become preferentially oriented along the axial and/or circumferential direction of the cylinder—that is, following the curve and/or length of the cylindrical wall, as opposed to along the radial direction—that is, along a direction pointing along a radius from the center of cylinder. FIG. 2. Illustrates the rolling of a pressed planar foam (left) into a cylindrical foam (right) with the various directions labelled. (The axial direction extends into the page and is represented by a black dot.)

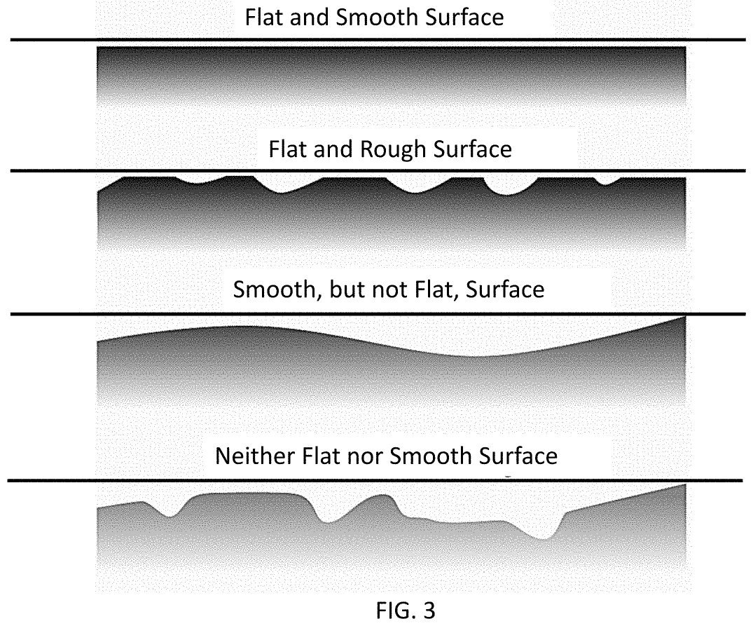

Another evident change caused by the compression of the foams is an increased flatness of the top and bottom surfaces of the foams, relative to the top and bottom surfaces prior to compression and relative to the surfaces of the side edges prior to and following compression. In the case of a compressed foam that has been formed into a hollow cylinder, the top and bottom surfaces will correspond to the outer and inner surfaces of the cylinder. As used herein, “flatness” refers to a global measurement of the surface topology across the top, bottom, or side edge surfaces, in contrast to roughness, which is a local measure of surface topology. The distinction between surface flatness and surface roughness is illustrated in FIG. 3. As shown in FIG. 3, flatness provided a measure of the deviation of the plane defined by the surface relative to a true horizontal plane (represented by the straight line above each surface in the figure.) The increased flatness of the top surface of a compressed metal foam, relative to the flatness of the side edge surface of the compressed metal foam, or the flatness of the top surface of an uncompressed metal foam, can be seen by a comparison of FIGS. 1L-1O with FIGS. 1E-1G or FIGS. 1H-1K.

Additionally, by compressing the metal foam starting material, the median pore size is reduced. For example, compression can reduce the median pore size of a metal foam by at least 25%, at least 50%, or even at least 75%. The resulting compressed metal foams can have a median pore size of, for example, 70 μm or smaller. This includes compressed metal foams having a median pore size of 60 μm or smaller, and further includes compressed metal foams having a median pore size of 50 μm or smaller. By way of illustration, some examples of the compressed metal foams have a median pore size in the range from 30 μm to 70 μm. However, compressed metal foams having a median pore size outside of this range can also be used.

As a result of the compression, the pores in the compressed metal foam are small enough to render the foam useful as a support for the in situ growth of a membrane. Notably, although the pores in the compressed foam may still be larger than those conventionally considered suitable for membrane growth, the inventors have shown that foam compression provides a fast, straightforward, and cost-effective route to compact metal support fabrication, even for high-performance applications, such as ethanol dehydration, as demonstrated in the Example below.

Depending upon whether the membrane of the composite structure will be an inorganic membrane (e.g., a zeolite membrane) or a mixed matrix membrane or a polymeric membrane, the metal foams are seeded with membrane seed particles, or inorganic (e.g., ceramic) filler particles. This seeding can be carried out before the initial metal foam is compressed (pre-seeding), such that the seed and/or filler particles are present during the pressing process, or after the initial metal foam is compressed (post-seeding), such that the seed and/or filler particles are incorporated into the foam after it is pressed. In addition, a combination of pre-seeding and post-seeding can be used, whereby particles are seeded into the metal foam before it is compressed and additional particles are seeded into the metal foam after it is compressed. Optionally, the initial metal foam can undergo a partial compression prior to seeding with membrane seed particles and/or ceramic filler particles and then undergo an additional compression to achieve the final desired reduction in porosity. To facilitate seeding, the membrane seed particles and/or ceramic filler particles should be sized such that they are able to infiltrate the pores of the metal foam and, desirably all the way through the foam.

Pre-seeding of a metal foam can be carried out by preparing a suspension of membrane seed particles and/or ceramic filler particles and infusing the suspension into the pores of the foam by, for example, immersing the metal foam in the suspension to embed the membrane precursor and/or filler particles in the metal foam. The metal foam can then be dried to remove the volatile components of the suspension, such as water and/or organic solvents, and then compressed. Post-seeding of a metal foam can be carried out by at least partially compressing the metal foam, followed by infusing a suspension of membrane seed particles and/or ceramic filler particles into the pores of the compressed metal foam, and then drying the foam. The membrane seed particle loading should be sufficient to fabricate a membrane having a desired coverage on the support, so that there are no uncovered regions on the surface of the seeded porous support.

Optionally, after seeding by either the pre-seeding or post-seeding method, the resulting seeded metal foam support may be coated with additional seed particles having a smaller particle size than the initial seed particles in order to further enhance the seed particle coverage of the foam support surface, which is beneficial for achieving high quality membranes.

As used herein, the term “membrane seed particles” refers to particles around which a continuous membrane is grown or formed in a subsequent processing step. The membrane seed particles may have the same chemical composition as the membrane itself or may have a different chemical composition than the membrane. Examples of membrane seed particles for the fabrication of inorganic membranes include zeolite particles and other ceramic particles. Ceramics include various inorganic compounds of metals, metalloids, and non-metals, including oxides, nitrides, and oxynitrides. Zeolites are crystalline porous aluminosilicates of sodium, potassium, calcium, and/or barium that have a wide range of applications in chemical separations and catalysis. For example, zeolite-NaA is a zeolite with highly hydrophilic properties and nanopores with diameters of approximately 0.3 nm to 0.5 nm that is used as a catalyst and adsorbent in a variety of chemical processes, including the selective removal of water from organic solutions.

For embodiments of the methods that use membrane seed particles to form an inorganic membrane in situ on the compressed metal foam, secondary hydrothermal synthesis can be used to convert the seed particles into a membrane. In hydrothermal synthesis, the seeded, compressed metal foam is exposed to a solution, such as an aqueous solution or gel, that includes chemical elements, molecules, and/or compounds containing the constituents of the membrane to be formed. These chemical elements, molecules, and/or compounds are referred to as membrane precursors. By way of illustration, the membrane precursors for a zeolite membrane would include aluminum- and silicon-containing elements, molecules, and/or compounds. Specific examples of membrane precursors that can be used to form a NaA zeolite membrane include sodium hydroxide, sodium metasilicate, nonahydrate, and sodium aluminate. Optionally, additional components, such as mineralizing agents and/or structure-directing agents can be included in the solution. Under hydrothermal conditions at elevated temperatures, the membrane precursors nucleate into crystals on the seed particles in the metal foam and grow into a continuous membrane. Hydrothermal membrane synthesis is generally carried out at elevated temperatures for a duration of hours or days. By way of illustration, hydrothermal zeolite membrane synthesis may be carried out at temperatures in the range from about 50° C. to about 250° C. for a period of about 5 hours to about 72 hours. However, temperatures and time periods outside of these ranges can be used. The resulting membrane may cover the entire surface of the compressed metal foam, or only a portion of the foam's surface. Because the membrane is grown from seed particles located within the pores of the metal foam, the membrane extends into the metal foam. That is, the membrane is integrated with the compressed metal foam, rather than being disposed only on the exterior surface of the metal foam.

If the membrane to be formed on the metal foam support is an organic polymer membrane, the particles seeded into the metal foam need not be membrane seed particles. Instead, ceramic filler particles can be used, the function of which is to reduce the pore volume in the metal foam and provide a substrate onto which a polymer coating can be applied in a subsequent processing step. As in the case of the membrane seed particles, the ceramic filler particles can be pre-seeded or post-seeded. The polymer membrane can be applied over the ceramic filler particles as a fully-polymerized polymer, or may be applied as polymer precursors that are subsequently polymerized and/or crosslinked into a polymer membrane. The polymer precursors are molecules, such as monomers, oligomers, crosslinking agents, and/or resins, that include the constituents of the polymer to be formed.

While the composite structures made according to the methods described herein can be designed for many applications, depending on the nature of the membranes, the structures having integrated hydrophilic zeolite membranes, such as NaA zeolite membranes, are particularly well-suited for use in the pervaporation of water from a feed stream comprising a mixture of water and one or more organic liquids, such as alcohols, esters, acids, and the like. In the pervaporation process, the hydrophilic zeolite membrane enhances the permeation and evaporation of water from the mixture through the membrane under the influence of a pressure difference across the membrane. Alcohols that can be dehydrated in this manner using the composite structures include, but are not limited to, ethanol and isopropanol. As demonstrated in the Example, dehydration via pervaporation can be accomplished with a high degree of water separation and at a high permeation flux.

### EXAMPLES

Example 1: This example describes the fabrication of composite structures formed from NaA zeolite membranes integrated with compressed Ni, Cu, and stainless-steel foam supports. This example further describes the use of the nickel foam-based structures in the dehydration of bioethanol.

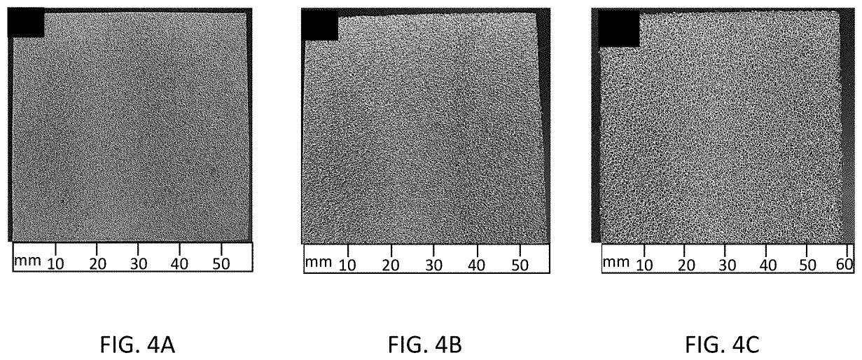

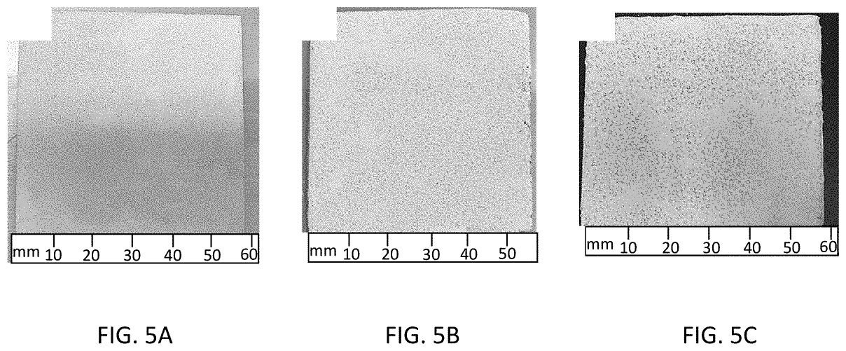

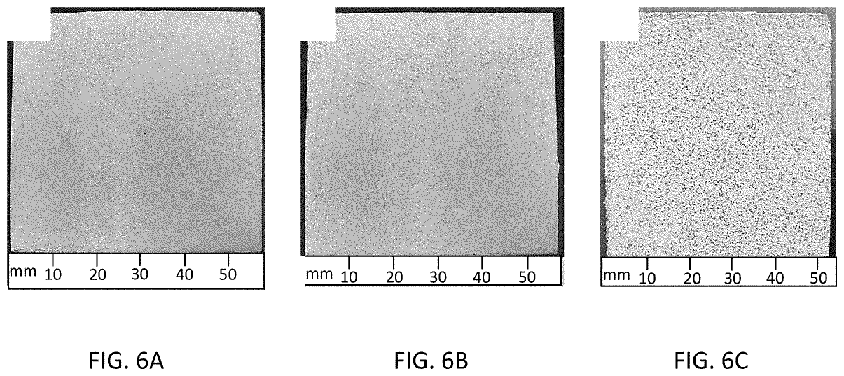

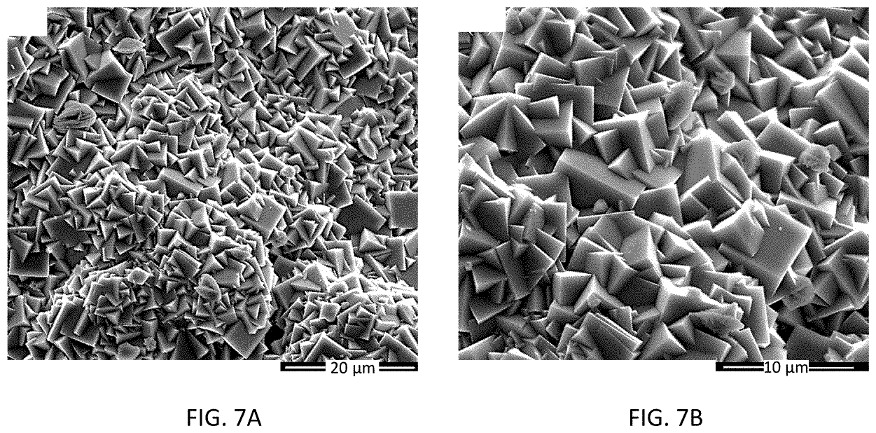

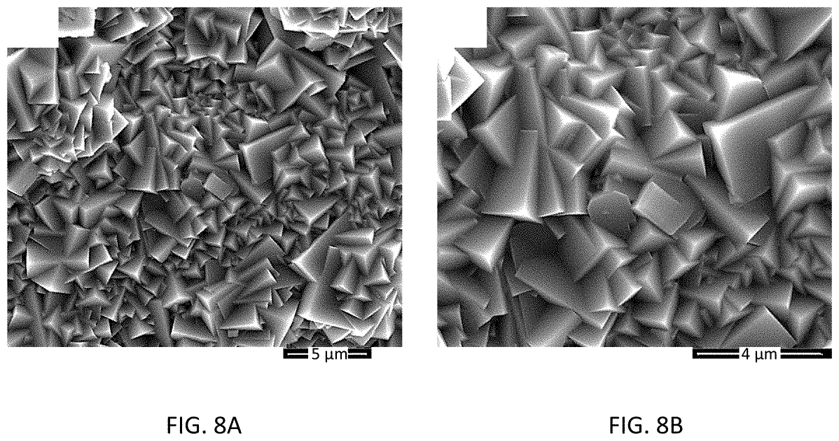

The metallic porous supports were prepared by pressing commercially available metallic foams at high pressures to reduce their pore size and porosity, thus making them suitable for NaA zeolite membrane synthesis. FIGS. 4A-4C show the pictures of Cu, stainless steel, and Ni foams. These metallic foams were cut into 5.6 cm×5.6 cm squares. The metallic foams were cleaned ultrasonically in acetone and deionized (DI) water sequentially for 10 min for each step, then dried in an oven at 50° C. overnight. The metallic foams were then seeded by two different seeding methods, i.e., pre-seeding and post-seeding, to prepare compact NaA-seeded metallic composite supports for NaA zeolite membrane synthesis. Pre-seeding involved infusing NaA zeolite powders into metallic porous supports, then drying the resulting composites in an oven, followed by final hydraulic pressing at a predetermined pressure. For the post-seeding method, a metallic foam was pressed under hydraulic pressing for partial densification, followed by seeding with NaA zeolite powders. FIGS. 5A-5C and FIGS. 6A-6B show pictures of pre-seeded and post-seeded Cu, Ni, and stainless-steel foams. The NaA powder seeded metallic porous support was then immersed in a chemical solution of sodium hydroxide, sodium metasilicate nonahydrate, sodium aluminate, and deionized (DI) water for hydrothermal synthesis at a temperature in the range of 80-100° C. for 8-48 hrs. After hydrothermal synthesis, a dense, thin, and continuous NaA zeolite membrane layer was formed on the surface of the metallic porous support. FIGS. 7A-7B and FIGS. 8A-8B show the SEM surface microstructure of NaA zeolite membranes synthesized on a pre-seeded and a post-seeded Ni metallic porous support, respectively.

The pervaporation and separation performance of the NaA zeolite membranes was evaluated by pervaporation separation of bioethanol aqueous feed solutions at different temperatures. As described below, the NaA zeolite membranes demonstrated a total pervaporation flux of 1.0-4.8 kg/h/m² with a OEtOH separation factor of ˜310-830 when separating a H₂O+90 wt. % EtOH mixture at 75° C.

### Pre-Seeding

A small size of Ni metallic foam with dimensions of 5.6 cm×5.6 cm was cut from a large Ni metallic foam sheet. The Ni foam was ultrasonically cleaned in an acetone bath for 15 min, then dried in an oven at 50° C. overnight. The cleaned metallic foam was initially pressed at 15 tons with a holding time of 1 min to adjust the porosity and pore size. The partially pressed Ni foam was then infused with commercial NaA powders (˜325 mesh, Sigma-Aldrich), and the resulting Ni/NaA composite porous support was then dried in an oven, followed by a final hydraulic pressing at 40 tons with a holding time of 1 min. The pre-seeded Ni foam was then dip-coated with lab-made NaA zeolite suspension which contains NaA powder particles with a size less than ˜1 μm to get a better coverage with NaA seeds on the porous support. The seeded NaA/Ni composite support was immersed in a chemical solution for hydrothermal synthesis at 80-100° C. for 8-48 hrs. After hydrothermal synthesis, the synthesized NaA zeolite membrane was rinsed with DI water several times, then dried in an oven at 50° C. overnight. The membrane was then ready for pervaporation dehydration of a 90 wt. % ethanol and water mixture.

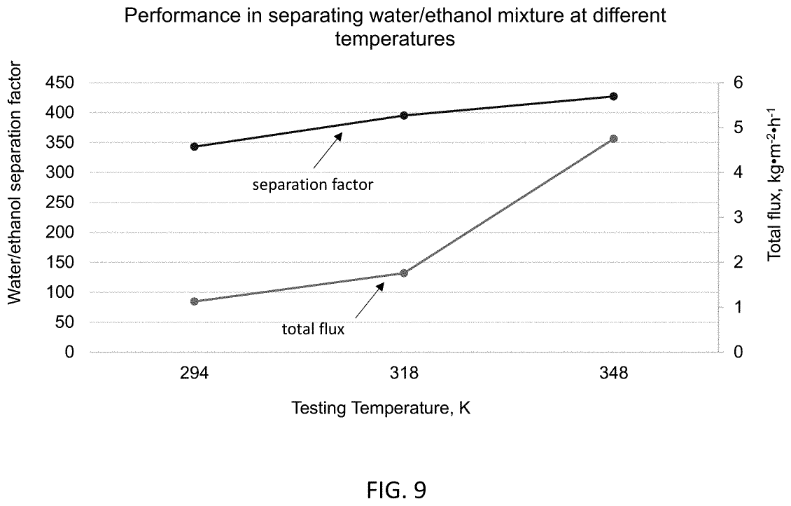

FIG. 9 shows the pervaporation performance of the NaA zeolite membrane synthesized on a pre-seeded metallic porous support in separating a 90 wt. % ethanol and water mixture at different temperatures. The membrane showed a H2O/EtOH separation factor of 343 with a total pervaporation flux of 1.13 kg·m⁻²·h⁻¹ at room temperature. As the testing temperature increased, both the H₂O/EtOH separation factor and total pervaporation flux increased. When the pervaporation testing temperature was increased to 45° C., the H₂O/EtOH separation factor and total flux were increased to 393 and 1.76 kg·m⁻²·h⁻¹, respectively. As the pervaporation temperature was further increased to 75° C., the separation factor increased to 427, while the total pervaporation flux more than doubled to 4.75 kg·m⁻²·h⁻¹.

### Post-Seeding

A small size of Ni metallic foam with dimensions of 5.6 cm×5.6 cm was cut from a large Ni metallic foam sheet. The Ni foam was ultrasonically cleaned in an acetone bath for 15 min, then dried in an oven at 50° C. overnight. The cleaned metallic foam was pressed at 35 tons with a holding time of 1 min to adjust the porosity and pore size. The pressed Ni foam was initially coated with commercial NaA powders (˜325 mesh, Sigma-Aldrich). The coated NaA/Ni composite support was dried at 50° C. overnight, followed by dip-coating with a lab-made NaA zeolite suspension which contains NaA powder particles with a size less than ˜1 μm to get a better coverage of NaA seeds on the surface of the porous support. The seeded NaA/Ni composite support was immersed in a chemical solution which was the same as the one used above for hydrothermal synthesis at 80-100° C. for 8-48 hrs. Similarly, the synthesized NaA zeolite membrane was rinsed with DI water and dried in an oven at 50° C. overnight before the pervaporation separation experiment.

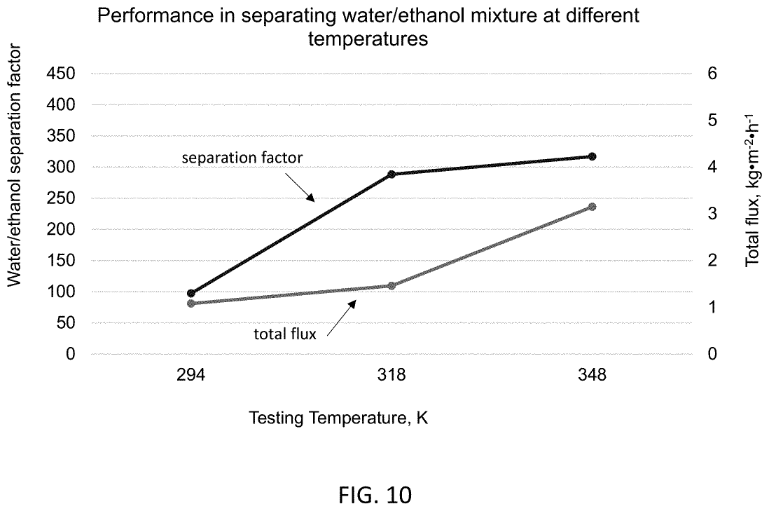

FIG. 10 shows the pervaporation performance of the NaA zeolite membrane synthesized on a post-seeded metallic porous support in separating a 90 wt. % ethanol and water mixture at different temperatures. The membrane showed a water/ethanol separation of ˜97 and a total flux of 1.08 kg·m⁻²·h⁻¹ at room temperature. As the testing temperature increased, both the water/ethanol separation factor and total flux increased. When the pervaporation testing temperature was increased to 45° C., the water/ethanol separation factor and total flux were increased to 288 and 1.46 kg·m⁻²·h⁻¹, respectively. As the pervaporation temperature was further increased to 75° C., the separation factor increased to 316, while the total flux more than doubled to 3.15 kg·m⁻²h⁻¹.

It is apparent that the zeolite volume fraction of a pre-seeded composite was generally higher than that of a post-seeded zeolite/metallic composite support. For this reason, the total pervaporation flux through the membrane synthesized on a pre-seeded support was usually higher than that of the membrane synthesized on a post-seeded support. This was also confirmed by the pervaporation separation results shown in FIG. 9 and FIG. 10. The membrane synthesized on the pre-seeded porous support (FIG. 9) showed a higher water/ethanol separation factor as well as higher total flux than the membrane synthesized on a post-seeded porous support (FIG. 10).

### Small-Sized Membrane

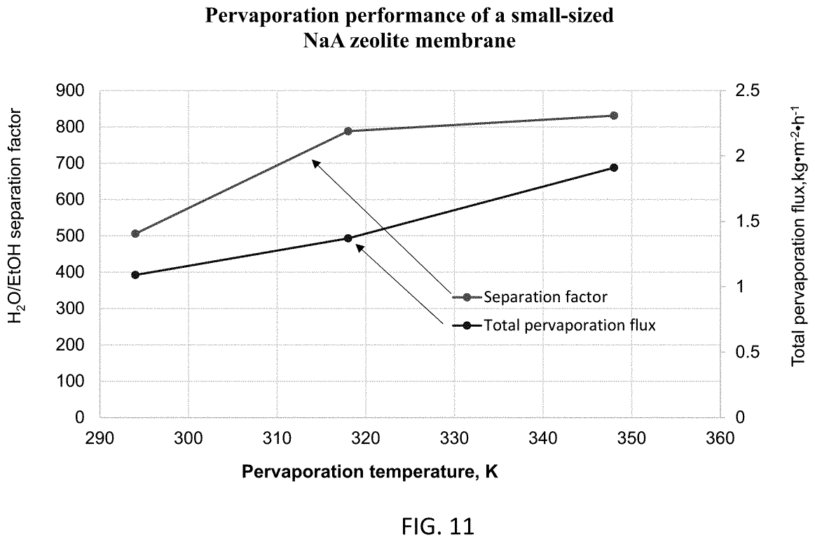

A small-sized NaA zeolite was synthesized on a pre-seeded Ni metallic porous support according to the procedure and synthesis conditions reported above. After hydrothermal synthesis, the membrane was rinsed several times with DI water and then dried in an oven at 50° C. overnight. The membrane was then loaded into a permeation cell for pervaporation dehydration of a 90 wt. % ethanol and water mixture at different temperatures. As shown in FIG. 11, the membrane exhibited a H₂O/EtOH separation factor and a total pervaporation flux of 506 and 1.09 kg·m⁻²·h⁻¹, respectively, at room temperature. As the pervaporation temperature was increased to 45° C., the H₂O/EtOH separation factor increased to 788, and the total pervaporation flux increased to 1.37 kg·m⁻²·h⁻¹. At 75° C., the H₂O/EtOH separation factor of the membrane was 831, which was higher than the results reported above. The total pervaporation flux of this membrane at 75° C. was 1.91 kg·m⁻²·h⁻¹ which was lower than that of the membrane described above. These results indicate that this membrane might have a lower defect density than the membrane described above, as this membrane showed a much higher H₂O/EtOH separation factor but a lower total pervaporation flux.

Example 2: This example illustrates one method of measuring the orientation of the struts in a compressed metal foam.

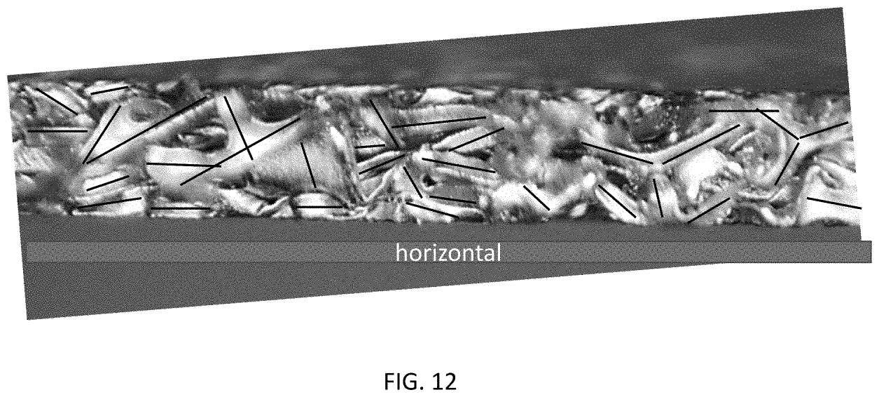

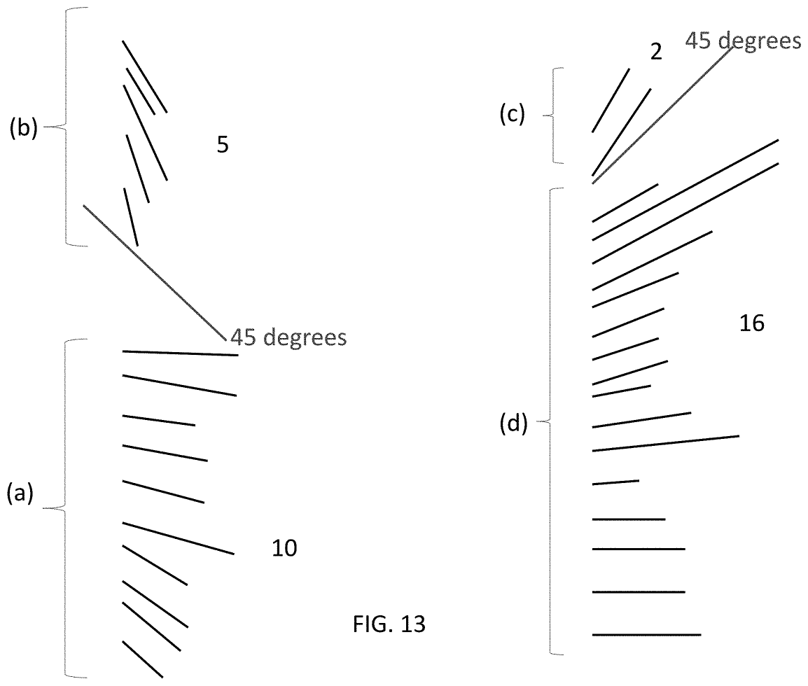

FIG. 13 shows the compressed nickel foam of FIG. 1F, with solid black lines oriented along the long axes of metal struts. FIG. 12 shows the corresponding collection of lines organized into groups as follows: (a) struts oriented at angles between 0° and 45°; (b) struts oriented at angles between 45° and 90° degrees; (c) struts oriented at angles between 90° and 135°; and (d) struts oriented at angles between 135° and 180°. The structs in groups (a) and (d) are considered to have a preferential horizontal orientation. Using this technique, a degree of preferential horizontal orientation, as calculated from the ratio of struts in groups (a) and (d) to the total number of struts, of greater than 70% is measured; or more precisely, 26/33=79%.

Although strut orientation was calculated using the edges of the compressed foam here, it could also be calculated using cross-sectional cuts through the compressed foams.

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more” or can mean only one. Both embodiments are covered.

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described in order to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A supported membrane comprising:
(a) a porous metal substrate having a first surface and a second surface disposed opposite the first surface, the porous metal substrate comprising a three-dimensional network of metal struts that define a plurality of open-cell pores, wherein:
the porous metal substrate is planar, the first surface is a top surface of the planar porous metal substrate, the second surface is a bottom surface of the planar porous metal substrate, an edge surface spans the top surface and the bottom surface, and the metal struts are preferentially horizontally oriented parallel to planes defined by the top and bottom surfaces; or
the porous metal substrate forms a hollow cylinder, the first surface is an outer cylindrical surface, the second surface is an inner cylindrical surface, a first end surface is located at one end of the hollow cylinder, a second end surface is located at an opposing end of the hollow cylinder, and the metal struts are preferentially oriented along a circumferential direction of the hollow cylinder, an axial direction of the hollow cylinder, or both; and
(b) a membrane supported by and integrated with the porous metal substrate.

2. The supported membrane of claim 1, wherein the porous metal substrate is the planar porous metal substrate.

3. The supported membrane of claim 2, wherein the top surface and the bottom surface have a higher surface flatness than the edge surface.

4. The supported membrane of claim 1, wherein the porous metal substrate forms the hollow cylinder.

5. The supported membrane of claim 1, wherein the inner cylindrical surface and the outer cylindrical surface have a higher surface flatness than the first and second end surfaces.

6. The supported membrane of claim 1, wherein the porous metal substrate has a median pore size of at least 2 μm.

7. The supported membrane of claim 1, wherein the membrane is an inorganic membrane.

8. The supported membrane of claim 7, wherein the inorganic membrane comprises an NaA zeolite.

9. The supported membrane of claim 1, wherein the porous metal substrate comprises, nickel, copper, or stainless steel.

10. The supported membrane of claim 1, further comprising ceramic particles in pores of the porous metal substrate, wherein the membrane is a polymer membrane that coats the ceramic particles and the porous metal substrate.

11. A supported membrane produced by the process of:
compressing a reticulated metal foam having an initial median pore size to produce a compressed reticulated metal foam having a reduced median pore size; and
forming a membrane on the surface of, and in the pores of, the compressed reticulated metal foam.

12. The supported membrane of claim 11, wherein the membrane is an inorganic membrane.

13. The supported membrane of claim 12, wherein the inorganic membrane comprises an NaA zeolite.

14. A method for separating water from a feed mixture comprising water and an organic solvent, the method comprising:
exposing the feed mixture to a first surface of a supported membrane under hydrothermal conditions, the supported membrane comprising:
(a) a porous metal substrate having a first surface and a second surface disposed opposite the first surface, the porous metal substrate comprising a three-dimensional network of metal struts that define a plurality of open-cell pores, wherein:
the porous metal substrate is planar, the first surface is a top surface of the planar porous metal substrate, the second surface is a bottom surface of the planar porous metal substrate, an edge surface spans the top surface and the bottom surface, and the metal struts are preferentially horizontally oriented parallel to planes defined by the top and bottom surfaces; or
the porous metal substrate forms a hollow cylinder, the first surface is an outer cylindrical surface, the second surface is an inner cylindrical surface, a first end surface is located at one end of the hollow cylinder, a second end surface is located at an opposing end of the hollow cylinder, and the metal struts are preferentially oriented along a circumferential direction of the hollow cylinder, an axial direction of the hollow cylinder, or both; and
(b) a hydrophilic zeolite membrane supported by and integrated with the porous metal substrate, and
creating a pressure difference between the first surface and the second surface, wherein the pressure at the first surface is greater than the pressure at the second surface, or vice versa, and water is selectively removed from the feed mixture via pervaporation through the hydrophilic zeolite membrane.

15. The method of claim 14, wherein the hydrophilic zeolite membrane comprises NaA zeolite.

16. The method of claim 14, wherein the organic solvent comprises an alcohol.

17. The method of claim 16, wherein the alcohol is ethanol.
